(19) United States
(12) Patent Application Publication
(10) Pub. No.: US 2022/0366469 A1
(43) Pub. Date: Nov. 17, 2022

(54) SMART LINK FOR OUTSIDE NETWORK INPUT/OUTPUT

(71) Applicant: KwikClick, LLC, Murray, UT (US)

(72) Inventor: Fred Cooper, Farmington, UT (US)

(21) Appl. No.: 17/706,106

(22) Filed: Mar. 28, 2022

Related U.S. Application Data
(60) Provisional application No. 63/166,801, filed on Mar. 26, 2021.

(51) Int. Cl. G06Q 30/06; H04L 9/40

(52) U.S. Cl. CPC G06Q 30/0613; H04L 63/0428

(57) ABSTRACT

Disclosed herein is a system and method to allow sellers of products to enroll an individual product in a multi-level marketing (MLM) organization by providing an MLM computer with a seller and a product to be sold. Individuals that purchase a product may be allowed to become MLM sellers of the prodcut. A second purchaser can do the same, by purchasing the product and advertising to a third purchaser, and so on. Commissions may be paid out users that are upline of a purchaser. New members may be provided with a code and link to the purchased product to allow the purchasers to pass the code and the link onto others and these others may become part of the MLM tree. Data within the system can be quickly retrieved from outside sources using a smart link directs to an online or offline portal through which data may be viewed and/or manipulated.

### CROSS-REFERENCE TO RELATED APPLICATION

The present application claims the priority benefit of U.S. provisional application No. 63/166,801 filed Mar. 26, 2021, the disclosure of which is incorporated herein by reference.

### BACKGROUND

### Field of the Disclosure

The present disclosure is generally related to multi-level marketing systems and commissions offered to users. More specifically, the present disclosure is directed to marketing products based on the use of linking information.

### Description of the Related Art

A multi-level marketing (MLM) system is a sales strategy used by some direct sales companies to encourage existing distributors to recruit new distributors. Amway, which sells health, beauty, and home care products, is an example of a well-known direct sales company that uses multilevel marketing. Existing distributors are paid a percentage of their recruits' sales. The recruits are referred to as a distributor's “downline.” Distributors also make money through direct sales of products to customers.

Multi-level marketing is, in and of itself, a legitimate business sales strategy. But MLMs are often organized as a pyramid tree. Pyramid “schemes” that use money from new recruits to pay those at the top of the pyramid rather than those who perform valid work or offer legitime services is illegal. As a result, pyramid schemes will involve taking advantage of people by pretending to be engaged in legitimate multilevel or network marketing. Illicit pyramid schemes are often identifiable by their greater focus on recruitment than on product sales. Multi-level marketing companies will typically either sell products primarily to consumers or to its members who must recruit new members to buy their products. In the case of the former, the company is likely a legitimate multilevel marketer. In this case of the latter, there often tend to be issues relative to an illegal pyramid scheme.

While each MLM company dictates its own financial compensation plan and payouts of earnings to their respective participants, all MLM compensation plans will tend to pay out to participants only from two potential revenue streams. The first is paid out from commissions of sales made by the participants directly to their own retail customers.

MLM distributors are expected to sell products directly to end-user retail consumers by means of relationship referrals and word of mouth marketing. But most importantly, they are incentivized to recruit others to join the company's distribution chain as fellow salespeople. As a result, new recruits can become down line distributors for those individuals also working above them.

Current MLM systems do not incorporate incentivizing users of a multi-level marketing system by offering a dynamic commission tree. Nor do current systems allow products to be sold based on queries from users that are used to generate smart links based on information included in a query and a search that identifies information that corresponds to or matches data in the query. There is this a need for improved methods and apparatus that allow users to participate in MLM and other related marketing techniques using their personal computing devices and other social networking and engagement tools.

### SUMMARY OF THE PRESENTLY CLAIMED INVENTION

The presently claimed invention is directed to a method and to a non-transitory computer-readable storage medium where a processor executes instructions out of a memory to implement a method for merchandising products. In a first embodiment, a method of the presently claimed invention may include parsing a received query to identify information, searching a database to identify data that matches the information, identifying a location associated with the information, and generating a link that includes information associated with the location. The link may then be provided for receipt by a user device and the method may include initiating a process to purchase the product after receiving an indication that the link has been selected. The product may then be purchased and the purchase may be fulfilled after the election of the link.

In a second embodiment, the presently claimed method is implemented as a non-transitory computer-readable storage medium where a processor executes instructions out of a memory. Here again the method may include the steps of parsing a received query to identify information, searching a database to identify data that matches the information, identifying a location associated with the information, and generating a link that includes information associated with the location. The link may then be provided for receipt by a user device and the method may include initiating a process to purchase the product after receiving an indication that the link has been selected. The product may then be purchased and the purchase may be fulfilled after the election of the link.

### DESCRIPTION OF THE DRAWINGS

FIG. 1 illustrates a system for Multi-Level Marketing of products via a set of computing devices.

FIG. 2 illustrates a method that may be performed by a computer such as the administration computer of FIG. 1.

FIG. 3 illustrates steps that may be performed by a computer such as the administration network computer of FIG. 1.

FIG. 4 illustrates steps that may be performed at an administration network computer when a smart link is used.

FIG. 5 illustrates a computing system that may be used to implement an embodiment of the present invention.

### DETAILED DESCRIPTION

Disclosed herein is a system and method to allow sellers of products to enroll an individual product in a multi-level marketing (MLM) organization by providing an MLM computer with a seller and a product to be sold. Individuals that purchase a product may be allowed to become MLM sellers of the product. A second purchaser can do the same, by purchasing the product and advertising to a third purchaser, and so on. Commissions may be paid out to users that are upline of a purchaser. New members may be provided with a code and link to the purchased product to allow the purchasers to pass the code and the link onto others and these others may become part of the MLM tree as downline distributors.

Data within the system can be quickly retrieved from outside sources using a smart link. The smart link directs to an online or offline portal through which data may be viewed and/or manipulated. An MLM tree may be a set of users associated with each other based on those users purchasing a same product. Each of the users of an MLM tree may receive commissions when new users or users that they sponsored became members of an MLM organization after purchasing a product associated with the MLM organization.

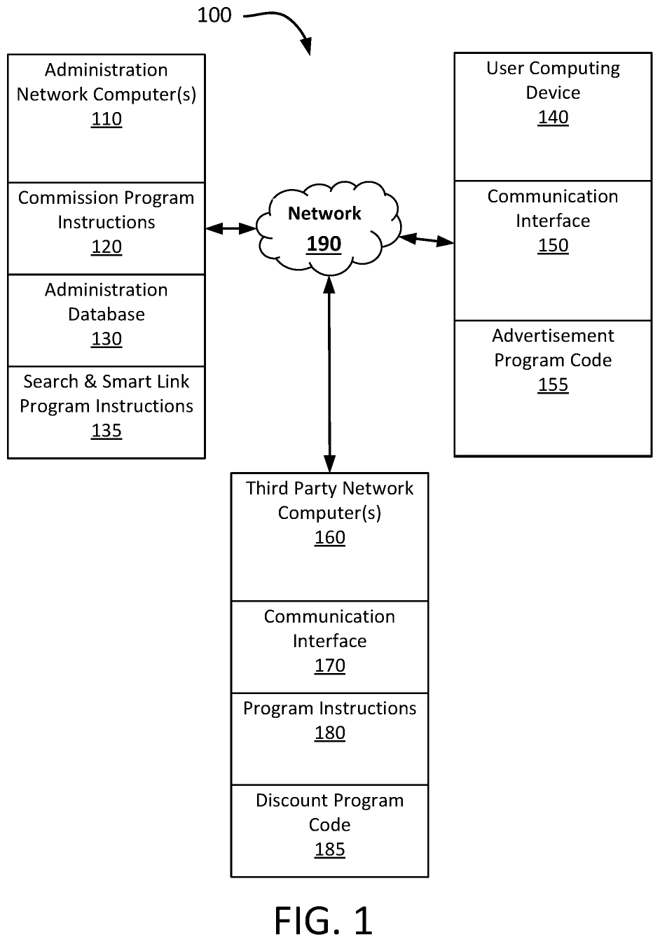

An administration network computer, like that shown in FIG. 1, identifies that a product has been purchased from a user(s) of the system (i.e., a first user). The system may generate an embedded coded link that connects (links) the referrer to the purchaser(s). This link may be shared automatically or manually depending on the referring party preference. The computer may then automatically pay remuneration, in the form of a commissions, referral, and/or finder fees, to the first user.

Additionally, the purchaser(s) becomes a second user(s) of the system. Should a new individual buy the same product from the second user(s), another embedded coded link may connect the first user to not only the second user but the new individual(s) as well. Both the first and second user of the system are remunerated for the new individual(s) purchase.

This wave of creating and recreating users (1, 2, 3, etc.) based on purchases and linking them together may be indefinitely iterative. Remuneration on this specific product may be paid to all users linked together in the system, each time a purchase is made. The links may be unique and are fixed to each good or service being referred.

FIG. 1 illustrates a system 100 for Multi-Level Marketing of products via a set of computing devices. The system 100 of FIG. 1 includes an administration computer or “administration network” computer 110, a user computing device 140 (user device), and a third-party network computer 160. Each of the devices of FIG. 1 (i.e., the administration network computer 110, the third-party 160, and user device 140) may communicate with each other via a communications network 190 such as the Internet or other cloud computing systems like Amazon Web Services.

A memory at the administration network computer 110 may store commission program instructions 120 and one or more sets of instructions relating to searching internal data & the generating and processing of smart links 135 executed by a computer processor, and an administration database 130. Search and smart link instructions 135 may allow a processor of administration network computer 110 to search administration database 130 for information relevant to received queries and to generate smart links that may point to locations where this relevant information is stored. User device 140 of FIG. 1 may be any user device such as a laptop, smartphone, tablet, computer, or smart speaker which may include a user device communication interface 150 which may be a network interface and a set of advertisement program code instructions 155 executed by a computer processor. Advertisement program instructions 155 may allow the processor of administration network computer 110 to view and or generated promotional materials.

The third party network computer 160 of FIG. 1 may include program instructions 180 and discount program code instructions 185 executed by a computer processor, a memory, and a communication interface 170 which may be a network interface. Program instructions 180 may allow third party vendors or retailers to update or provide product offerings that may be viewed by users accessing the administration network computer 110. In certain instances, a processor at the administration network computer 110 may receive data regarding sales, execute notification program instructions, track rankings, and send notifications to users. In such an instance, the administration network computer 110 may receive the sales data from the third party network computer 160 such that rankings can be identified and notifications can be sent to user devices from administration network computer 110.

Use of the system may be as follows. A user submits a request to register a product with the administration network computer 110 via a set of discount program code instructions 185 on a third party network computer 160. A set of program instructions relating to searching internal data & the generating and processing of smart links 135 on the administration network computer 110 determine if the requested registration is valid under a set of rules. If the request for registration is valid, the product is registered and stored in the administration database 130. A user connects a user device 140 to the communication network 190 via the user device communication interface 150. Through the communication network 190 the user device 140 connects with the third party network computer 160 via the third party network communication interface 170. A set of third party network program instructions 180 allow third party vendors or retailers to update or provide product offerings that may be viewed by users accessing the administration network computer 110. Discount program code instructions 185 allow the user to purchase the registered product from the third party network computer 160 and apply a discount to the product if a user has a code. Confirmation of the purchase and the code are then sent from the third party network computer 160 to the administration network computer 110. If the user did enter a code, a set of administration network commission program instructions 120 will pay commission to at least another user that is associated with the code. A new code is then generated by the administration network 110 per the administration network commission program instructions 120. The new code is associated with the user of the user device 140. The commission and the newly generated code are stored in the administration network administration database 130. The administration network computer 110 may also receive sets of filter data from a user device 140 and the administration network computer 110 may then send advertisements, marketing data, or other promotional materials to the user device 140 that match a set of criteria included in the filter data. A user of user device 140 may then be allowed to update marking materials or generate their own advertisements that may be provided to and shared by the administration network computer 110 with other users.

Program code instructions of the administration network computer 110 may be organized as one or more software modules that include instructions for performing different functions. For example, a set of commission program instructions 120 may include base program instructions, advertising program instructions, calculation program instructions, instructions associated with searching databases, instructions associated with generating or evaluating smart links, and vendor program instructions. The administration network computer 110 may also access one or more databases, 130 such as a compensation database that stores compensation data and a code database that stores program code or web link data, for example. The administration network computer 110 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 110 may also provide a plurality of buyers/distributors, allow the at least one first seller to enroll a product to the MLM system, and allow at least a first buyer/distributor to purchase the product. Other functions that may be performed by the administration network computer 110 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Once products have been enrolled with a commission structure, the administration network computer 110 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools. A service may refer to a system supplying a public need such as transport, communications, or utilities such as electricity or water.

A service which may be an act of dealing with a customer in a store, restaurant, or hotel by taking their orders, showing, or selling them goods. Additionally, a service which may be work that someone does or time that someone spends working for an organization, or a business that offers a particular type of help or work.

A purchasing process may begin with the user device 140 polling for the code and the link from the administration network computer 110. The user device 140 receives the code and the link from the administration network computer 110. The user device 140 provides a selection of the first follower in the user device user database. The user device 140 extracts the followers contact information stored in the user device user database. Then the user device 140 sends the code and link to the follower's contact information. The code and link may be shared on social media sites, such as Twitter, Instagram, Facebook, etc. This may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. When the user device 140 determines that there are no more followers remaining in the user device user database, then the process may end.

Methods of the present disclosure may include a user device 140 polling for a new universal resource locator (URL) that may have been detected after a quick release (QR) code scanner scans a QR code. The data captured by the QR code scanner may contain data in addition to or in lieu of a URL. The administration network computer 110 may then send the URL to a web browser on the user device 140 so that the user device is directed to the website the URL points to. Third parties may design this webpage so that users can easily refer others to make the same purchase they did or purchase from the same third party or third party computer. Website URLs may be product, user, location, or discount code specific, or may be general but could require the user to provide information before granting the user a referral code or link.

A third party network computer 160 may execute administration program instructions to cause the third party network computer 160 to connect to the administration network computer 110, send the data for the products to be purchased, receive a link from the administration network computer 110, store the link in a third party network database, and return to executing a set of base program instructions. The process may begin with the third party network computer 160 administration program instructions being initiated by the third party network base program instructions. The third party network 160 may connect to the administration network computer 110 and then the third party network computer 160 may send third party network database data to the administration network computer 110. Then the third party network computer 160 may store the link in the third party network third party database.

Operation of a third party network discount program code instructions may include extracting a link sent by the user device 140 and comparing it to data stored at the third party network third party database. This may result in the identification of a corresponding discount for a selected product. This process may include identifying whether a user entered a code or not, after which a discount is applied, and the order is processed.

The process of applying a discount may begin by extracting the link received from the user. Then the third party network computer 160 may compare data included in the extracted link to data stored at the third party network database. The third party network computer 160 may then extract a corresponding discount from the third party network third party database. Then the third party network computer 160 may apply the extracted discount to the user's order. The third party network computer 160 may then determine if the user entered a code. When it is determined that the user did not enter a code, the third party network computer 160 may send the user data to the administration network computer 110 without a code. When it is determined that the user entered a code, the third party network computer 160 may send the code and the user data to the administration network computer 110. Next, the third party network computer 160 may process the user's order.

A third party network third party database may store information about the products that may be purchased. This the third party network database may include local media for the product or service, where this local media may refer to the various types of media, such as photos, videos, text, sounds, haptics, online product descriptions, etc. for enhanced marketing.

In certain instances the administration network computer 110 polling for product data from the third party network computer 160. Product data includes at least the product ID, user ID, original cost, discount, and decay rate. The administration network computer 110 compares the product ID from the product data send by the third party network computer 160 to the product ID in a rules database. The administration network computer 110 determines if there is an identical ID in the product data and the rules database. If there is a matching product ID, the administration network computer 110 extracts the rest of the data stored in that entry of the rules database.

The administration network computer 110 determines if the user ID from the product data matches one of the extracted valid user IDs. When the user ID is valid, the administration network computer 110 determines if the original cost component of the product data is above or equal to the minimum original cost from the rules database for that product. When the original cost is not above the minimum original cost from the rules database for that product, the cost may be set to the minimum original cost instead of denying the entire product. When the original cost is above the minimum original cost, the administration network computer 110 determines whether the original cost component of the product data is below or equal to the maximum original cost from the rules database for that product. If the original cost is not below the maximum original cost from the rules database for that product, the cost may be set to the maximum original cost instead of denying the entire product.

The administration network computer 110 determines if the discount component of the product data is above or equal to the minimum discount from the rules database for that product. If the discount is not above the minimum discount from the rules database for that product it may be set to the minimum discount instead of denying the entire product. When the discount is above the minimum discount, the administration network computer 110 may determine whether the discount component of the product data is below or equal to the maximum discount from the rules database for that product. When the discount is not below the maximum discount from the rules database for that product, the discount applied may be set to the maximum discount instead of denying the entire product.

The administration network computer 110 may determine whether the decay rate component of the product data is above or equal to the minimum decay rate from the rules database for that product. When the decay rate is not above the minimum decay rate from the rules database for that product, the decay rate may be set to the minimum decay rate instead of denying the entire product. When the decay rate is above the minimum decay rate, the administration network computer 110 determines whether the decay rate component of the product data is below or equal to the maximum decay rate from the rules database for that product. When the decay rate is not below the maximum decay rate from the rules database for that product, the applied decay rate may be set to the maximum decay rate instead of denying the entire product.

If none of the parameters fall outside the allowed values, the administration network computer 110 may store the product data in the administration database 130. The administration network computer 110 may send an update to the third party network computer 160 that the product has been registered. This update may be, for example, a Boolean TRUE, or the string “allowed”. If one or more of the parameters for the product fall outside the allowed values, the administration network computer 110 sends an update to the third party network computer 160 that the product has been denied. This update may be, for example, a Boolean TRUE, or the string “denied”, and may also contain the reasons the product was denied.

The system 100 of FIG. 1 may distribute commissions according to an MLM tree or commission tree that is a payment structure in which commissions are given out at different percentages at different levels of the MLM tree, for example. In such a system distributor (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor, and a third distributor that signed up the second distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 110 may perform data security functions as well as functions associated with operation of an MLM algorithm that may calculate user compensation. Administration network computer 110 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

The commission program instructions 120 of FIG. 1 may cause a computer processor in the administration network computer 110 to continuously poll for user data (e.g., data of a user who may be a product purchaser or product distributor) from another processor executing a set of program instructions 180 at a third party network computer 160. Once the processor of the administration network computer 110 receives the user data, commissions may be calculated using the commission program instructions 120 of FIG. 1. These commissions may be calculated based on data stored in an administration network compensation database. Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third party network computer 160, the third party network computer 10 may send the user data to the administration network computer 110 after a sale has been made.

A processor executing the commission program instructions 120 of FIG. 1 may continuously poll for user data from the third party network computer 160. The administration network computer 110 may then receive the user data from the third party network computer 160. Then the administration network computer 110 may determine whether the user entered a code. If the user did enter a code, the processor at the administration network computer 110 may extract the code and then access the administration network compensation database to identify one or more different spheres of influence or potential product purchasers/distributors levels. Such a code may have been received from user device 140 based on user inputs. A sphere of influence may be a set of related users the received marketing materials from each other and that each purchased a particular product.

The administration network computer 110 may then extract a corresponding commission for the code that was retrieved from in the administration network compensation database. The administration network computer 110 may then send the commission to the user (purchaser/distributor). The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 110 may also compare the extracted code to data stored at an administration network code database a list of users and code sent to followers may be stored. This administration network code database may be the same database as the administration database 130 of FIG. 1 or it may be another database accessible by the administration network computer 110. The administration network computer 110 may extract a user ID and sphere of influence or potential purchaser/distributor by using the extracted code.

The administration network computer 110 may then compare the extracted sphere of influence or potential purchaser/distributor to data stored at the administration network compensation database. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The administration database 130 may store data received from various third parties (various sellers) that are part of a set of MLM trees. This data may contain a product ID, description of the product, an original cost of the product, a discount for the product, a cost of the product with the discount, a compensation plan decay rate, and a link to the product. An advertising link may refer to a link that directs a consumer to a product, service or good.

TABLE 1
Administration Database Data

| Third Party | Home Depot | Home Depot | Furniture Store | Pharmacy |
|---|---|---|---|---|
| ID | 6554123 | 789654 | 123789 | 456812 |
| Item | Drill | Table Saw | Couch | Cold Medicine |
| Origional Cost | $59.00 | $119.00 | $999.00 | $25.00 |
| Discount | 15% | 10% | 10% | 5% |
| Discount Cost | $50.15 | $107.10 | $899.10 | $23.75 |
| Compensation | 50% | 50% | 30% | 50% |
| Decay Rate | | | | |
| Link | HDDrill654123 | HDTSaw789654 | FSC123789 | PCM456812 |

Table 1 table displays data that may be stored at the administration database 130 of FIG. 1. When the administration network computer 110 receives product data from third party network computer 160 it creates a link for the product, stores the received data in the administration network administration database 130, and sends the created link back to the third party network computer 160. The administration network administration database 130 may be used to store data collected from various third parties that enrolled in the multi-level marketing system 100 of FIG. 1. The administration network administration database 130 may store the name of the third party, a user ID, the ID for a product, a description of the product, the original cost of the product, the discount provided by the third party, the cost of the product with the discount, the compensation decay rate or how the downline commissions are calculated, and the link to the product. A user ID and product ID may each include a unique set of alphanumeric characters that respectively identify a particular user and a particular product.

The data of table 1 cross-references a name of a third party (e.g. Home Depot, Furniture Store, and Pharmacy), an identifier (ID) for an item, a description or name of the item, an original cost of the item, a discount provided by the third party, a discounted cost of the item, a compensation decay rate, and a link to the item. In some instances, administration network database 130 store data that identifies downline/upline communications, dynamic incentives/rewards for successfully marketing a product, marketing materials, banking referrals, materials for suggestive selling, or other data. Here the downline/upline communications may identify advertising events to participants of an MLM system. Dynamic incentives and rewards for a product may refer to incentives or rewards that are continuously updated for a product. Marketing materials may refer to a means of marketing, advertising, or promotional materials developed by or for a license (or subject to licensee's approval) that promote the sale of the licensed product, including but not limited to, television, radio and online advertising, point of sale materials (e.g. posters, counter-cards), packaging advertising, print media and all audio or video media. In some embodiments, banking referrals may refer to a structured flow of collecting and organizing referrals for banks. Businesses who have been unsuccessful in a credit application process with a bank will be asked for their permission to have their financial information passed to designated finance platforms that can contact the business in a regulated time-frame. Suggestive selling may refer to a sales technique where an employee asks a customer if they would like to include an additional purchase or recommends a product that might suit the client,

The administration database 130 may store data that the administration network computer 110 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

Program instructions relating to searching internal data & the generating and processing of smart links 135 may allow a processor to receive data for a product that could potentially be added to products sold via an MLM organization. Data stored internally to one or more databases may be searched by a processor executing instructions of program code that may be referred to as an internal search module. These searches may be performed based on received query data. The search query data may have been received based on manual user input and may have been received based on a user entering information into or by selecting data via a graphical user interface (GUI). Once query data is received from a user device, such as user device 140 of FIG. 1, an administration computer may validate the query data. If the data is valid, the administration computer may search a database for information that matches data included in the query in step 320. Step 320 may also include parsing the query data to identify a specific database to search. For example, a query may be a command in the format of a structured query language (SQL) statement of “SELECT FROM Administration Database WHERE Country=‘Mexico,” in which case the select statement may command that a selected database be searched. Data that matches the query may be searched for and information that matches the query may be stored in step 330. This may include identifying a location within the database where the matching database data resides. This location maybe identified by a cell location reference, for example, “ADMIN_DATABASE_11_1” may indicate that the location of the database is the 11th row and the first column of a particular data set. Such a location may be a location in physical memory, for example, memory address “0x52A132F3.”

In certain instances, a smart link may be generated by concatenating each piece of data into a URL hyperlink, for example, “www.example.com/data1/data2/data3/data4 . . . ” or, if the data has been compressed and encrypted, “www.example.com/4Qm4SDqfw8u7BuHYqAAr”. A domain name may be included within the smart link that can be used to direct a user device to a website. This may be performed via an administration portal that may itself be part of the administration network computer or be located at another computer. A smart link may be provided to users and purchases associated with those smart links may result in commissions being paid to a chain of related users that are upline of another user or a purchaser. When a user or potential purchaser selects a link, information may be sent to administrations network computer 110 that may then decompress and/or decrypt the location data in the smart link, provide data to a user device, and facilitate a process where a product is purchased.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g., follower user devices), preparing advertisement information to share with follower user devices, receiving advertisement information prepared by other users, accessing product promotions at the third party network computer 160, and purchasing products based on offerings received from the third party network computer 160. Each of the tasks performed by user device 140 may include sending and receiving communications with the administration network computer 110, the third party network computer 160, or other user devices. Promotions prepared at a particular user device may be shared with other user device via administration network computer 110, third party network computer 160, a social media network computer, or directly from one user device to another. User devices may also be required to download and install an application program from an application store, such as the “Apple App store” as part of a process for registering as a member of an MLM organization.

The influence program code instructions 155 may cause the processor to direct the user to a web page associated with a universal resource locator (URL) received in a communication that advertises a product. In certain instances, the URL may be encoded on a QR code. When the QR codes is scanned, a computing device that scanned the QR code may be directed to the web page. A QR code scanner may be an input device, such as a camera. The QR code may contain non-URL data which may be usable by other program instructions. For example, the QR code may contain a pre-generated referral code or a product ID which, when combined with the user's ID, can be used to retrieve a referral code from an administration network code database. This QR code may also include discount information that allows the product to be purchased at a reduced price.

As discussed above the third party network computer 160 of FIG. 1 may include a computer processor a memory, and communication interface 170. This third party network computer 160 may be controlled by various third parties, such as retail stores (stores that sell product consumables, services, service networks, large box stores) or e-commerce sites that allow e-commerce sales. Such e-commerce sites may include an e-commerce shopping cart, that offer products to users at a discount, such as a product discount, in order to use the MLM system of FIG. 1. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduce price or something being sold at a price lower than that product is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network program instructions 180 and discount program code instructions of FIG. 1 may be executed by a computer processor after being initiated by a set of third party network base program instructions. These instructions may cause the processor at the third party network computer 160 to prompt user for a discount code and to compare a received code to data stored at a third party network third party database. When a code received from a user matches data stored at the databases, a discount for the selected product may be applied and an order for a product may be processed.

The discount program code instructions 185 may allow a user to register products and a set of associated parameters with the administration network computer 110 so long as the parameters are within the allowed values set by the rules. These product parameters may include, for example, the product ID, the name, the cost, the discount, or the compensation decay rate, etc. mentioned above.

The communications network 190 of FIG. 1 may be the Internet or a cloud. This communication network or any of the communication network interfaces 150 or 170 discussed herein may be a wired and/or a wireless network. Such a communication network, if wireless, which may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

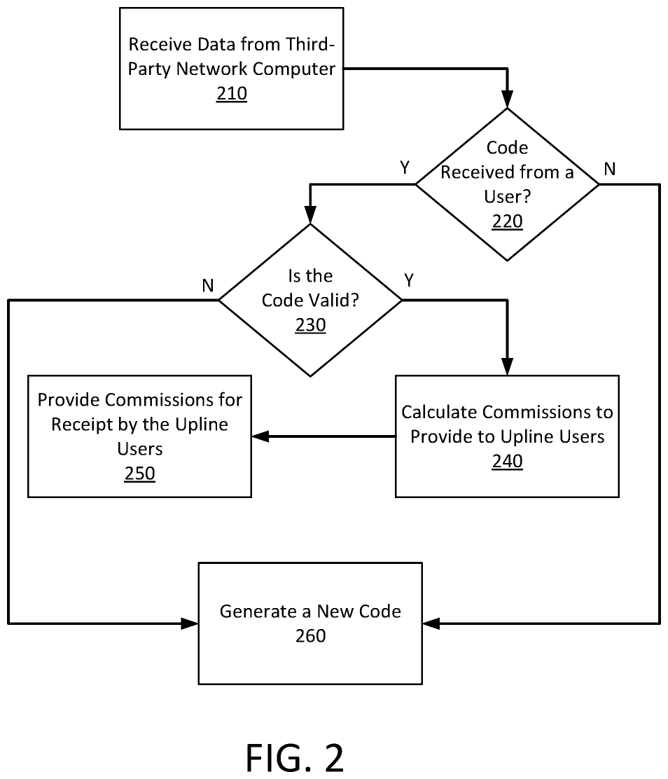

FIG. 2 illustrates a method that may be performed by a computer such as the administration computer of FIG. 1. FIG. 2 begins with step 210 where the administration network computer 110 receives data from the third party network computer 160 of FIG. 1. The received data may contain information on a purchased product and the discount code that can be applied to the purchase. The administration network computer 110 may determine if the data received from the third party network computer 160 contains a code, at step 220. When the data does contain a code, the administration network computer 110 checks that both the product and the code match data stored at the administration network administration database 130 and/or other databases. The product and code may then be checked to see if they are valid at step 230 of FIG. 2. When the code and product are valid, the computer at administration network computer 110 may calculate commissions due to each upline user at step 240.

The commissions may be calculated by using the discount on the product and providing 50% of the discount to the user who supplied the code and then the remaining amount of the discount for the upline users at a 50% decay rate. For example, if the first user purchased a product that was originally $59.00 discounted by 15%, then a second user makes a purchase with the first user's code would receive $3.32 or 50% of the discount. Then any follower of the second user who uses the second user's code would cause the second user to receive 50% of the discount and the first user to receive 50% of the remaining discount or 50% of $3.32, and this may continue until there is only one cent left to pay out as a commission for the upline users. The threshold at which commission stops may be greater or less than one cent and may be set dynamically. This step may be facilitated by administration network calculation program instructions stored in memory and executed by a processor. Then, the administration network computer 110 may distribute the commission to the upline users at step 250 of FIG. 2. Commission may be paid directly to a user via the user device 140 of FIG. 1. The data may be stored in a database, for example, an administration network compensation database discussed above. Whether or not a valid code was entered, the administration network computer 110 may generate a new code for the user such that the user can give the code to followers and receive commission on their purchases at step 260 of FIG. 2. This generated code may be stored in the administration database 130 of FIG. 1 or another database, for example an administration network code database.

A set of administration network base program instructions may instruct the administration network computer 110 to connect to the third party network computer 160, initiate a set of vendor program instructions and initiate a set of calculation program instructions.

A set of administration network calculation program instructions may administration network computer 110 to apply a discount and identify commissions that should be paid to particular users. Once identified, this commission data may be stored data in a database at the administration network computer 110 of FIG. 1. A commission may refer to a payment to someone who sells goods that are directly related to the amount sold, or a system that uses such payments. A compensation plan or a commission plan may refer to the decay rate of the commissions provided to the MLM system from the discount offered by the third party, the third party also selects the decay rate to calculate the commissions offered to the first purchaser as well as the percentage offered to the downline participants.

An administration network compensation database, which may be created through operation of the administration network calculation program instructions, may store various commissions for the different product purchasers/distributors. Table 2 illustrates data that may be stored at a compensation database consistent with the present disclosure.

The administration network compensation database may store information that cross-references a third party, a product ID, product description, the compensation plan decay rate, the various sphere of influence levels, a commission for each sphere of influence level, and a code to be used by the user's followers to enroll in the MLM system 100 of FIG. 1. The administration network compensation database may store a lottery structure for how the commissions are paid to users or freelancers. This lottery structure may refer to a process or thing whose success or outcome is governed by chance. A means of raising money by selling number tickets and giving prizes to the holders of number drawn at random. Freelancers may refer to a person who works as a writer, designer, performer, or the like, selling work or services by the hour, day, job, etc., rather than working on a regular salary basis for one employer.

TABLE 2
Compensation Database Data

| | | Home | Home |
|---|---|---|---|
| Third Party | Home Depot | Depot | Depot |
| ID | 654123 | 654123 | 654123 |
| Item | Drill | Drill | Drill |
| Compensation Decay | 50% | 50% | 50% |
| Rate | | | |
| Sphere of Influence | First | 2 | 3 |
| Level | Participant | | |
| Commission | $3.31 | $1.66 | $0.83 |
| Code | N/A | 654123- | 654123- |
| | | SOI2 | SOI3 |

Table 3 illustrates data that may be store at an administration network code database. This data may identify the codes given to the product purchasers/distributors (users) for the product purchasers/distributors (user) to pass to their potential purchasers/distributors to advertise or promote a product that a user has purchased. The administration network code may also cross-reference a user ID with a product ID, and product name, product and user relationships, and a code that may be shared with followers.

TABLE 3
Code Database Data

| | | | Product and User | Code for |
|---|---|---|---|---|
| User ID | ID | Item | Relationships | Followers |
| JS1234 | 654123 | Drill | First Participant | 654123-SOI2 |
| HY8569 | 654123 | Drill | Second Participant | 654123-SOI3 |
| TB4567 | 789654 | Table | First Participant | 897456-SOI2 |
| | | Saw | | |
| EL51346 | 789654 | Table | Second Participant | 897456-SOI3 |
| | | Saw | | |

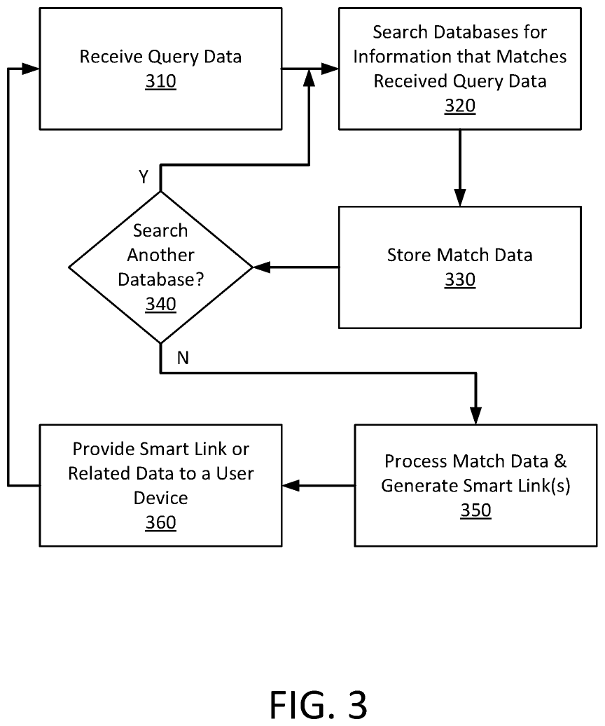

FIG. 3 illustrates steps that may be performed by a computer such as the administration network computer of FIG. 1 in accordance with embodiments of the presently disclosed invention. FIG. 3 begins with step 310 where query data is received. This may include polling for search query data. The search query data may have been received based on manual user input. Alternatively, the data may have been received based on a user entering information into or by selecting data via a graphical user interface (GUI).

Once query data is received from a user device, such as user device 140 of FIG. 1, an administration computer may validate the query data. If the data is valid, the administration computer may search a database for information that matches data included in the query in step 320. Step 320 may also include parsing the query data to identify a specific database to search. For example, a query may be a command in the format of a structured query language (SQL) statement of “SELECT FROM Administration Database WHERE Country=′Mexico,” in which case the select statement may command that a selected database be searched.

Data that matches the query may be searched for and information that matches the query may be stored in step 330. This may include identifying a location within the database where the matching database data resides. This location may be identified by a cell location reference. For example, “ADMIN_DATABASE_11_1” may indicate that the location of the database is the 11th row and the first column of a particular data set. Such a location may be a location in physical memory such as memory address “0x52A132F3.”

Next, determination step 340 may identify whether there is another database that could store data relevant to the query. When ‘yes,’ program flow may move back to step 320 where the other database is searched. When there is not another relevant database to search program flow may move to step 350 where sets of matching data are processed.

The processing of the sets of matching data may include a processor executing instructions that generate smart links that point to the locations of the matching data. This processing may include compressing and/or encrypting the matching data. This compression reduces shortens the characters used to express the data such that the smart link does not become too long for reasonable use. Each location of the sets of matching data from each database may be compressed.

For example, “ADMIN_DATABASE_11_1” may be shortened to “ADb1” where b is 11 in hexadecimal. An entire smart link may also need to be shortened using a short URL which may act as a substitute link that redirects to a web page or database that has stored or that can access. A longer URL of “www.example.com/ADb1/AD7f/CDed/AD714/” may be shortened to “www.short.com/link1” where “link1” uniquely directs to the longer URL. Encryption may occur before, after, or simultaneously to compression. In some instances, the link may not be encrypted when encryption is not necessary.

In other instances, a smart link may be generated by concatenating each piece of data into a URL hyperlink, for example, “www.example.com/data1/data2/data3/data4 . . . ” or, if the data has been compressed and encrypted, “www.example.com/4Qm4SDqfw8u7BuHYqAAr”. A domain name may be included within the smart link that can be used to direct a user device to a website. This may be performed via an administration portal that may itself be part of the administration network computer or be located at another computer.

In step 360 of FIG. 3, the administration network computer may send the generated smart link to the user device that originally provided the query. This generated smart link may be stored at a smart link database. The smart link or related data may be provided to a user via a communication portal of the administration network computer 110 of FIG. 1. This smart link or data that the smart link points to may be displayed in a graphical user interface of a user device.

Program flow may then move back to step 310 of FIG. 3 where another query may be receive at the administration network computer. In certain instances, a website that the smart link is directed to may be the third party network computer 160 of FIG. 1. Alternatively, this web site may be hosted by another computer accessible via the Internet.

Individuals who are not yet members of an MLM organization may be allowed to provide queries via their user device and their queries may allow them to receive smart links that direct them to product offerings associated with a group or tree of associated members of the MLM organization. Alternatively, members or non-members may be sent marketing materials, text messages, emails, or other communications that include a smart link generated by others. This may allow an MLM organization to grow based on the receipt of queries that result in a smarlink being generated or based on the receipt of a smart link.

Once a non-member purchases a product, they may be allowed to join a group of linked members that are associated with the product. Here, again, commissions may be paid to linked users after the product is purchased. The data stored at the database may have been generated by an upline member of the MLM organization. After a new member joins the MLM organization, they may be allowed to earn commissions based on joining an MLM tree when others purchase the product.

New members may also be allowed to generate their own marketing materials for the product they purchased using a smart link or they may be allowed to generate their own materials marketing the product or other products. As mentioned above, this could mean that users are not always relegated to being downline of other members. A first member that us upline of a second member based on a product purchase may be listed as downline of the second member for products that the first member purchased based on marketing materials provided by, generated by, or shared by the second member.

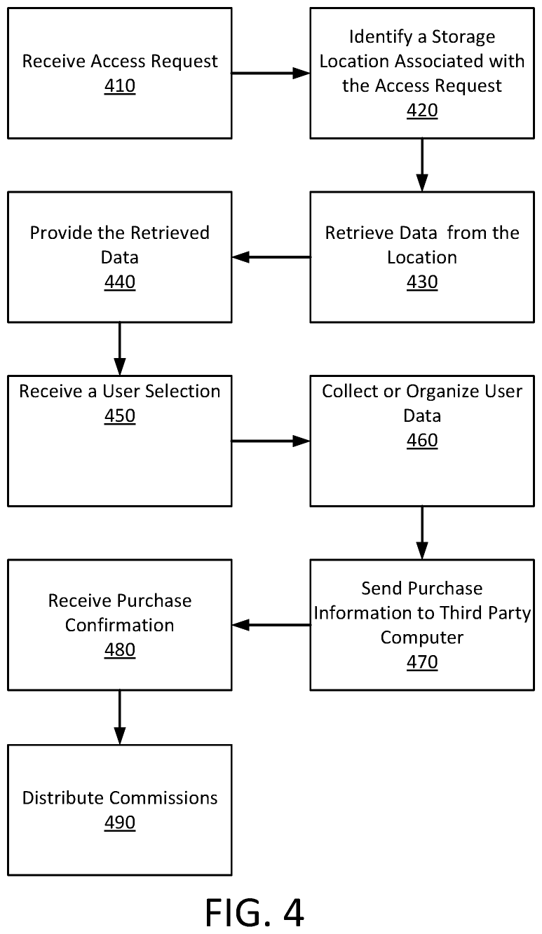

FIG. 4 illustrates steps that may be performed at an administration network computer when a smart link is used. In one instance, after a smart link is received at a user device, a user of the user device may select that smart link to access data associated with the smart link. The smart link may be received via the administration portal. The steps of FIG. 3 may be performed after. This smart link could include coded or compressed information that an administration computer may use to access or may be used to redirect an access request.

Step 410 of FIG. 4 is a step where an access request may be received. This access request may be received after a user selects a smart link at their user device. An administration computer may poll for user access requests. A smart link may be received via an administration computer or an indication that a smart link has been used may result in a redirection to a website via the administration portal. The smart link may be used to direct a user device to the administration portal.

The administration computer may receive the smart link that was used to direct to the administration portal or may receive only the portion of the smart link that contains relevant data. The administration network computer may then decompress and/or decrypt the location data in the smart link when necessary in step 420 of FIG. 4. A data storage location of data stored at a database internal to or accessible by the administration network computer may be identified in step 420.

The administration network computer may then use the location data to retrieve data in step 430. In an instance when the location data references “ADMIN_DATABASE_11_1,” then the administration network computer may retrieve the data that is stored in row 11 and column 1 of the database. Next in step 440, the administration network computer may provide the retrieved data to a user device. This data may be provided to the user device via the administration portal.

The data provided to the user device in step 440 may be associated with a product that can be purchased. A process for making a purchase may include polling for an access request. When a request is received, data may be accessed and provided to the user device. This data may allow the user device to be directed to a third party computer. A user selection that includes a code may optionally be provided to the administration network computer in step 450.

After step 450 user data may be collecting, accessed, or organized in step 460. Step 460 may also check to see whether the user provided a code. User data may include a name, an address, billing information, credit cart numbers, or information regarding a credit card system. In some embodiments, a credit card system may refer to a system that allows cardholders to borrow funds with which to pay for goods and services with the condition that the cardholders pay back the borrowed funds, plus interest, as well as any additional agreed-upon charges.

Purchase information may then be sent to a computer of a third party in step 470 such that a third party can administrate or fulfill the purchase of the product. Then, in step 480, a purchase confirmation may be received. The user may provide selections to the third party computer to purchase a product. After step 480, commissions discussed in respect to FIG. 2 may be distributed in step 490 to respective user's associated with the smart link discussed in respect to FIG. 3.

User data may be stored at a user database at or accessible by the administration network computer. User database data may cross-reference user identifiers (ID), the identifiers of followers, a code that was provided to the followers, the follower e-mail address information, follower phone numbers, or an address of a follower.

Table 4 displays data that may be stored at a user device database. The data of table 4 cross-references user information with user follower information. The user device user database stores the user's ID, the followers user ID, codes provided to the followers, the follower's e-mail address, the follower's phone number, and the follower's address. The user device database may store the follower's social media information such as user social media account information (Twitter, Instagram, and Facebook).

The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls or blogs.

TABLE 4
User Database Data

| | | | |
|---|---|---|---|
| User ID | JS1234 | JS1234 | JS1234 |
| Follower ID | HY8569 | IT8527 | RW4569 |
| Code for | 654123-SOI2 | 654123-SOI2 | 654123-SOI2 |
| Followers | | | |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, Boston, | 58 Elm Street, | 96 2nd Ave, Salt |
| Address | MA | Burlington, VT | Lake City, UT |

Operation of a set of user device downline program instructions may cause the user device 140 to poll to receive the code and link from the administration network computer 110 to allow the purchaser/distributor to pass the code and link to the user's followers stored in the user device user database. Functioning of the downline program instructions may be as follows.

Table 5 illustrates data that may be stored at a third party database. This data may include information about the products enrolled in the MLM system as well as a link created by execution of the administration network vendor program instructions. The third party network database may cross-reference a product ID, and product description, an original cost of the product, a discount provided by the third party for the product, a cost of the product with the discount, a compensation plan decay rate which the third party enters, and a link received from the administration network computer. The third party network third party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another product (identical or different), or a store credit.

The information about the product or service which may be advertisements to the network, or as seen on TV sales. Advertisements to the network may refer to the advertisement provided to the MLM system from the third party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points.

TABLE 5
Third Party Database Data

| | |
|---|---|
| ID | 654123 |
| Item | Drill |
| Original Cost | $59.00 |
| Discount | 15% |
| Discount Cost | $50.15 |
| Compensation Decay | 50% |
| Rate | |
| Link | HDDH11654123 |

Table 6 illustrates data that may be stored at a database accessible by an administration computer. This data may include information that cross-references advertisement information with user IDs and follower codes. Users may have provided several different forms of advertising media that can be shared with their followers and computing devices of these followers may be sent links that include a follower code in table 6 and may include links that point to or that include one or more media files. Note that user JS12345 is associated with follower code 654123-SO12, with marketing text (“I Love this new Drill”) and with three different media files (Drill.mov, Drill.png, and Drill.mp3). These follower codes may be linked to the user and to a product based on specific information included in the follower code. In certain instances based on the follower codes being unique. Note that user JS12345 may be upline of user HY8570 for sales related to a particular type of drill, yet each user may be associated with a same chain of users that can receive compensations when their advertising materials generate new sales of the drill.

TABLE 6
Administration Advertisement Data

| | | | | |
|---|---|---|---|---|
| User ID | JS12345 | HY8570 | JS1235 | EL51347 |
| Follower | 654123-SO12 | 654123-SO13 | 897456-SO12 | 897456-SO13 |
| Codes | | | | |
| Text | “I Love this New | N/A | “I Do Love | “I don't usually make |
| | Drill” | | this Table | posts, yet had to |
| | | | Saw” | because this product |
| | | | | works so Well” |
| Media File | Drill.mov | New_drill.jpeg | Tablesaw.mov | Cutting_Steel_1.jpeg |
| 1 | | | | |
| Media File | Drill.png | N/A | Tablesaw.png | Cutting_Steel_2.jpeg |
| 2 | | | | |
| Media File | Drill.mp3 | N/A | Tablesaw.mp3 | Cutting_Steel_N.jpeg |
| N | | | | |

A database associated with the administration network computer or at the third party network computer may store information about items enrolled in the MLM system as well as the links that may have been created at an administration network computer. This database may store data that identifies a cost of the item with the discount, the compensation plan decay rate which the an administration of the third party computer enters, and the link received from the administration network computer. In some instances, this databases may store data that identifies rates of exchange for product returns, marketing materials, airline sky miles, etc.

In some embodiments, product returns may refer to a process in which a customer or consumer takes previously purchased product, merchandise, or goods back to the retailer, and in turn receives a refund in the original form of payment, exchange for another item (identical or different), or a store credit. In some instances, the information about the product or service may be advertisements to the network, or as seen on TV sales. Advertisements to the network may refer to the advertisement provided to the MLM system for an offering of a product, a good, or service. In some embodiments, as seen on TV sales may refer to a generic nameplate for products advertised on television in the United States for direct response mail-order through a toll-free telephone number. In some instances, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, airline sky miles may refer to a loyalty program offered by airlines and/or credit cards. Typically, consumers accumulate a set amount of miles based on how much is spent on a ticket or a credit card and are also known as frequent flyer miles or travel points.

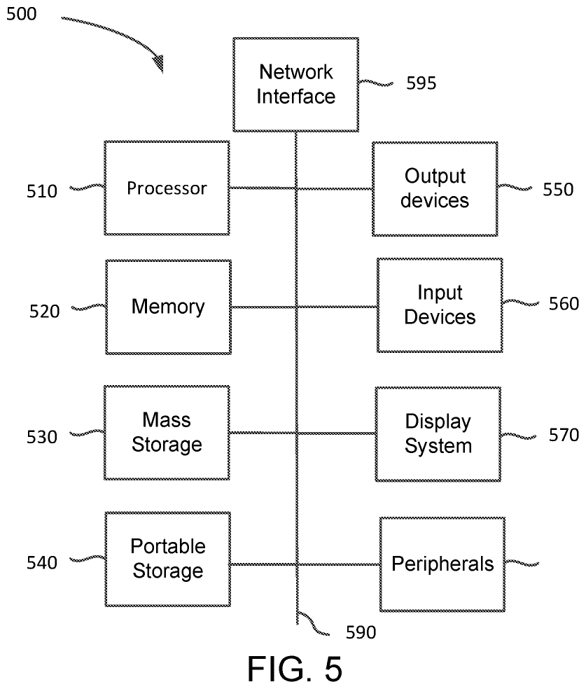

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

What is claimed is:

1. A method for merchandising products, the method comprising:
parsing a received query to identify information;
searching a database to identify data that matches the information;
identifying a location associated with the information;
generating a link that includes information associated with the location, wherein the link is provided for receipt by a user device; and
initiating a process to purchase the product after receiving an indication that the link has been selected, wherein the product is purchased and the purchase is fulfilled after the election of the link.

2. The method of claim 1, further comprising:
providing the user device with data associated with the product; and
receiving a selection from the user device.

3. The method of claim 1, further comprising redirecting the user device to a computer of an entity that fulfills the purchase of the product.

4. The method of claim 2, further comprising redirecting the user device to a computer of an entity that fulfills the purchase of the product according to the selection.

5. The method of claim 1, further comprising compressing data when generating the link.

6. The method of claim 1, further comprising compressing and encrypting data when generating the link.

7. The method of claim 1, further comprising encrypting data when generating the link.

8. The method of claim 1, further comprising accessing stored user data that identifies information regarding a user that purchased the product, wherein the user data is sent to a third party computer such that the product is provided to the user and a purchase confirmation is received from the third party computer.

9. The method of claim 1, further comprising distributing commissions to a set of related users based on the purchase and fulfillment of the product.

10. The method of claim 1, further comprising:
associating a first member as being upline of a second member for subsequent sales of the product based on the second member purchasing that product after accessing data associated with the first member, wherein the first member purchases a second product based on data associated with the first member; and
associating the second member as being upline of the first member for subsequent sales of the second product based on the first member purchasing the second product after accessing data associated with the second member.

11. A non-transitory computer-readable storage medium having embodied thereon a program executable by a processor for implementing a method for merchandising products, the method comprising:
parsing a received query to identify information;
searching a database to identify data that matches the information;
identifying a location associated with the information;
generating a link that includes information associated with the location, wherein the link is provided for receipt by a user device; and
initiating a process to purchase the product after receiving an indication that the link has been selected, wherein the product is purchased and the purchase is fulfilled after the election of the link.

12. The non-transitory computer-readable storage medium of claim 11, the program further executable to:
provide the user device with data associated with the product; and
receive a selection from the user device.

13. The non-transitory computer-readable storage medium of claim 11, the program further executable to redirect the user device to a computer of an entity that fulfills the purchase of the product.

14. The non-transitory computer-readable storage medium of claim 12, the program further executable to redirect the user device to a computer of an entity that fulfills the purchase of the product according to the selection.

15. The non-transitory computer-readable storage medium of claim 11, the program further executable to compress data when generating the link.

16. The non-transitory computer-readable storage medium of claim 11, the program further executable to compress and encrypt data when generating the link.

17. The non-transitory computer-readable storage medium of claim 11, the program further executable to encrypt data when generating the link.

18. The non-transitory computer-readable storage medium of claim 11, the program further executable to access stored user data that identifies information regarding a user that purchased the product, wherein the user data is sent to a third party computer such that the product is provided to the user and a purchase confirmation is received from the third party computer.

19. The non-transitory computer-readable storage medium of claim 11, the program further executable to distribute commissions to a set of related users based on the purchase and fulfillment of the product.

20. The non-transitory computer-readable storage medium of claim 11, the program further executable to:
associate a first member as being upline of a second member for subsequent sales of the product based on the second member purchasing that product after accessing data associated with the first member, wherein the first member purchases a second product based on data associated with the first member; and
associate the second member as being upline of the first member for subsequent sales of the second product based on the first member purchasing the second product after accessing data associated with the second member.
